(19) United States
(12) Patent Application Publication
(10) Pub. No.: US 2026/0219129 A1
(43) Pub. Date: Jul. 30, 2026

(54) LOSS MEASUREMENT DEVICE AND LOSS MEASUREMENT METHOD

(71) Applicant: NTT, Inc., Tokyo (JP)

(72) Inventors: Ryota IMADA, Musashino-shi, Tokyo (JP); Taiji SAKAMOTO, Musashino-shi, Tokyo (JP); Takayoshi MORI, Musashino-shi, Tokyo (JP); Yusuke YAMADA, Musashino-shi, Tokyo (JP); Kazuhide NAKAJIMA, Musashino-shi, Tokyo (JP)

(73) Assignee: NTT, Inc., Tokyo (JP)

(21) Appl. No.: 19/143,899

(22) PCT Filed: Jan. 23, 2023
(86) PCT No.: PCT/JP2023/001948

§ 371 Date: Jun. 27, 2025

(51) Int. Cl. G01M 11/02; G01M 11/00

(52) U.S. Cl. CPC G01M 11/0207; G01M 11/33

(57) ABSTRACT

A loss measurement device includes: a laser light source inputting light to one end of an optical fiber; a measurement unit measuring intensity of light outputted from the other end of the optical fiber; a bend applying unit inverting an extending direction of the optical fiber by bending with a predetermined bending radius; and a rotation unit rotating a section of the optical fiber bent by the bend applying unit on a central axis of the optical fiber, and a loss measurement method includes: rotating an optical fiber using a rotation unit; setting a bending angle indicating a bending direction of the optical fiber in a plane perpendicular to a central axis; and calculating a bending loss of the optical fiber on the basis of the intensity at a plurality of bending angles.

### TECHNICAL FIELD

The present disclosure relates to a loss measurement device and a loss measurement method.

### BACKGROUND ART

Non Patent Literature 1 discloses that a bending loss generated when a coupled multi-core optical fiber (CMCF) is bent varies depending on a bending angle indicating a direction in which the CMCF is bent in a plane perpendicular to an axis of the CMCF. Therefore, it is disclosed that it is necessary to calculate an average value of bending losses at a plurality of bending angles in order to measure the bending loss of the CMCF.

### CITATION LIST

### Non Patent Literature

Non Patent Literature 1: Ryota Imada, Taiji Sakamoto, Takayoshi Mori, Yusuke Yamada, and Kazuhide Nakajima, “Ketsugo Gata Maruchi Koa Faiba Ni Okeru Mage Sonshitsu No Koa Suu/Mage Houkou Izonsei (in Japanese) (Dependency of Bending Loss in Coupled Multicore Fiber on Number of Cores and Bending Direction)”, The Institute of Electronics, Information and Communication Engineers (IEICE) Communication Society Conference B-13-1, 2022

### SUMMARY OF THE INVENTION

### Technical Problem

In order to measure the bending loss of the CMCF by averaging the bending losses at a plurality of bending angles, it is necessary to sufficiently increase the number of windings of the CMCF. However, when the number of windings is increased, overlapping or slack of the optical fiber is likely to occur, and there is a problem that it is difficult to stably measure the bending loss.

The present disclosure has been made in view of the above problem. An object of the present invention is to provide a loss measurement device and a loss measurement method capable of stably measuring a bending loss at a plurality of bending angles of an optical fiber without increasing the number of windings of the optical fiber, and easily calculating an average value of bending losses at the plurality of bending angles.

### Solution to Problem

In order to solve the above-described problem, a loss measurement device according to an aspect of the present disclosure includes: a laser light source that inputs light to one end of an optical fiber; a measurement unit that measures intensity of light outputted from the other end of the optical fiber; a bend applying unit that inverts an extending direction of the optical fiber by bending with a predetermined bending radius; and a rotation unit that rotates a section of the optical fiber bent by the bend applying unit on a central axis of the optical fiber. A loss measurement method includes: rotating an optical fiber using a rotation unit; setting a bending angle indicating a bending direction of the optical fiber in a plane perpendicular to a central axis; and calculating a bending loss of the optical fiber on the basis of the intensity at a plurality of bending angles.

### Advantageous Effects of Invention

According to the present disclosure, it is possible to stably measure bending losses at a plurality of bending angles of an optical fiber without increasing the number of windings of the optical fiber, and easily calculate an average value of the bending losses at the plurality of bending angles.

### BRIEF DESCRIPTION OF DRAWINGS

FIG. 1 is a schematic diagram illustrating a configuration of a loss measurement device according to an embodiment of the present disclosure.

FIG. 2 is a diagram illustrating an example of a change in a bending loss with respect to a bending angle in a coupled two-core optical fiber.

FIG. 3 is a diagram illustrating a change in a relative error with respect to angular resolution.

FIG. 4 is a diagram illustrating an example of a change in a bending loss with respect to a bending angle in a non-coupled two-core optical fiber.

FIG. 5 is a schematic diagram illustrating a configuration of a loss measurement device according to a modification of the present disclosure.

FIG. 6 is a diagram illustrating an example of a measurement result of a bending loss with respect to a bending angle.

FIG. 7 is a diagram illustrating an example of an average value of measurement results of a bending loss.

### DESCRIPTION OF EMBODIMENTS

Next, an embodiment of the present disclosure will be described in detail with reference to the drawings. In the description, the same components are denoted by the same reference signs, and redundant description will be omitted.

### Configuration of Loss Measurement Device

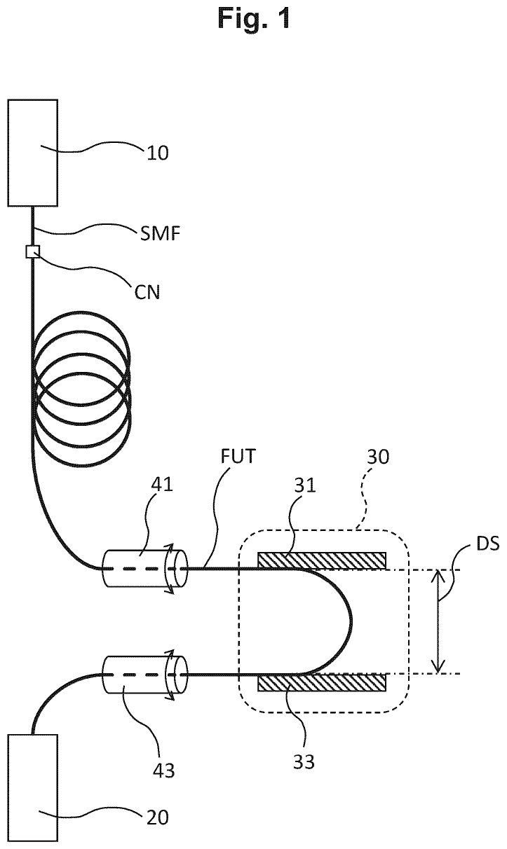

FIG. 1 is a schematic diagram illustrating a configuration of a loss measurement device according to the present embodiment. As illustrated in FIG. 1, the loss measurement device includes a laser light source 10, a measurement unit 20, a bend applying unit 30, and rotation units 41 and 43. An optical fiber FUT whose loss is to be measured by the loss measurement device is supported by the bend applying unit 30 and the rotation units 41 and 43, and is further connected with the laser light source 10 and the measurement unit 20.

The laser light source 10 is connected with the optical fiber FUT via an optical fiber SMF and a connector CN, and light outputted from the laser light source 10 is introduced into one end of the optical fiber FUT. The optical fiber FUT is an optical fiber to be measured by the loss measurement device. For example, the optical fiber FUT may have at least two or more cores. Light outputted from the laser light source 10 may be introduced into one end of each core of the optical fiber FUT.

In addition, the optical fiber SMF may be a single-mode optical fiber. Light outputted from the laser light source 10 may be directly introduced into one end of the optical fiber FUT without passing through the optical fiber SMF.

The measurement unit 20 measures the intensity of light outputted from the other end of the optical fiber FUT. That is, the measurement unit 20 is connected with an end different from the end, into which light from the laser light source 10 is introduced, among ends of the optical fiber FUT. For example, the measurement unit 20 is an optical power meter. The measurement unit 20 may include a photodiode sensor that measures the intensity of light as a current value by photoelectric effect.

Note that the conversion from the intensity of light to a current value in the measurement unit 20 may vary in efficiency depending on the wavelength of received light. Therefore, in order to ensure the reliability of the measurement result of the intensity in the measurement unit 20, the measurement unit 20 may be correctly calibrated at the wavelength of light outputted from the laser light source 10.

The bend applying unit 30 inverts the extending direction of the optical fiber FUT by bending with a predetermined bending radius. More specifically, as illustrated in FIG. 1, the bend applying unit 30 includes two parallel flat plates 31 and 33 separated from each other by a distance DS that is twice the bending radius. Then, the bend applying unit 30 sandwiches the optical fiber FUT between the flat plates 31 and 33. As a result, the extending direction of the optical fiber FUT is folded back by 180 degrees in the section of the optical fiber FUT sandwiched between the flat plates 31 and 33. Hereinafter, a section of the optical fiber FUT sandwiched between the flat plates 31 and 33 will be referred to as “the section”.

Note that, in FIG. 1, a cross section in a plane orthogonal to the planes of the flat plates 31 and 33 is illustrated, and the section exists in the cross section. The bending radius can be adjusted by adjusting the distance DS between the flat plates 31 and 33.

The rotation units 41 and 43 rotate the section of the optical fiber FUT on the central axis of the optical fiber FUT. The rotation units 41 and 43 may be installed at least either ahead or behind the section along the extending direction of the optical fiber FUT. FIG. 1 illustrates a state in which the rotation units 41 and 43 are installed both ahead and behind the section.

The rotation units 41 and 43 control the bending angle by rotating the optical fiber FUT on the central axis at an arbitrary angle while fixing the optical fiber FUT with a jig. Here, the “bending angle” represents a bending direction of the optical fiber FUT in a plane perpendicular to the central axis of the optical fiber FUT. The rotation by the rotation units 41 and 43 may be manually performed, or may be automatically performed using a motor (not shown) or the like.

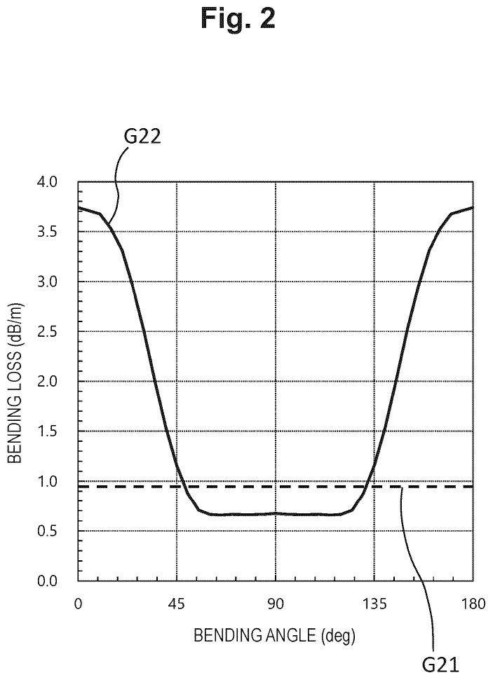

Moreover, the maximum value of the rotation angle when the rotation units 41 and 43 rotate the section of the optical fiber FUT on the central axis of the optical fiber FUT is 180 degrees or more. The reason therefor will be described with reference to FIG. 2.

FIG. 2 is a diagram illustrating an example of a change in a bending loss with respect to a bending angle in a coupled two-core optical fiber. In FIG. 2, the change in the bending loss with respect to the bending angle in a coupled two-core optical fiber is shown by a curve G22 (solid line). For comparison, the change in the bending loss with respect to the bending angle in a one-core optical fiber is shown by a curve G21 (broken line) in FIG. 2.

The bending loss in the one-core optical fiber is shown as a substantially constant value without depending on the bending angle. On the other hand, the bending loss in the coupled two-core optical fiber varies depending on the bending angle. As described above, since the bending loss of the coupled multi-core optical fiber varies depending on the bending angle, it is necessary to measure the bending loss at a plurality of bending angles and calculate an average value of bending losses at the plurality of bending angles.

Moreover, the bending loss in the two-core optical fiber changes with respect to the bending angle at a cycle of 180 degrees. Thus, in order to measure the bending loss at a plurality of bending angles, it is necessary to rotate the optical fiber by at least 180 degrees or more.

From the above reasons, the maximum value of the rotation angle when the rotation units 41 and 43 rotate the section of the optical fiber FUT on the central axis of the optical fiber FUT is required to be 180 degrees or more.

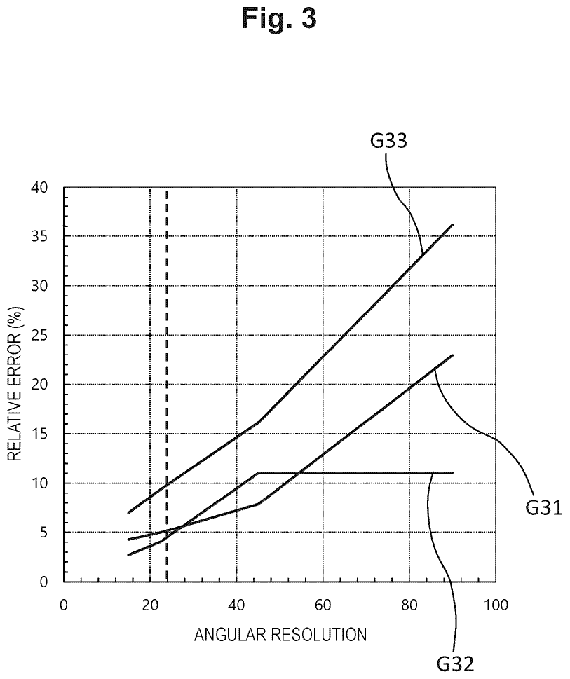

Furthermore, the rotation angle when the rotation units 41 and 43 rotate the section of the optical fiber FUT on the central axis of the optical fiber FUT can be set with an angular resolution of 24 degrees or less. The reason therefor will be described with reference to FIG. 3.

FIG. 3 is a diagram illustrating a change in a relative error with respect to an angular resolution. The relative error is defined as a maximum value of an error of an average value of bending losses at a plurality of bending angles obtained at a certain angular resolution with respect to a true value of an average value of bending losses at a plurality of bending angles.

In FIG. 3, the change in the relative error in a four-core optical fiber is shown by a curve G31. The change in the relative error in an eight-core optical fiber is shown by a curve G32. The change in the relative error in a 12-core optical fiber is shown by a curve G33.

For example, the bending loss of a standard optical fiber (ITU-T G.652) is defined as 0.1 dB. An optical power meter used as the measurement unit 20 has a power resolution of approximately 0.01 dB. Therefore, it can be seen that a relative error at the time of measurement by the loss measurement device of 10% or less is sufficient.

In FIG. 3, the error with respect to the angular resolution is the maximum in the curve G33. Thus, it can be seen that the optical fiber having the maximum error with respect to the angular resolution is the 12-core optical fiber. Thus, in order to set the relative error to 10% or less, it is necessary to measure the bending loss of the optical fiber FUT at a plurality of bending angles set at an angular resolution of 24 degrees or less.

From the above reasons, it is required that the rotation angle when the rotation units 41 and 43 rotate the section of the optical fiber FUT on the central axis of the optical fiber FUT can be set at an angular resolution of 24 degrees or less.

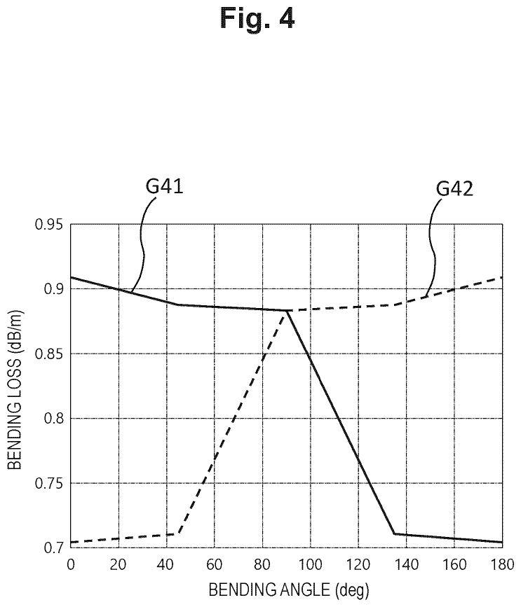

In addition, a point will be supplemented that it is necessary to measure the bending loss at a plurality of bending angles not only in a coupled multi-core optical fiber but also in a non-coupled multi-core optical fiber. FIG. 4 is a diagram illustrating an example of a change in a bending loss with respect to a bending angle in a non-coupled two-core optical fiber. In FIG. 4, the change in the bending loss in the first core of a two-core optical fiber is shown by a curve G41. The change in the bending loss in the second core of the two-core optical fiber is shown by a curve G42.

As illustrated in FIG. 4, it can be seen that the bending loss varies depending on the core in addition to varying depending on the bending angle. This is because the distance from the center of bending to the core varies depending on the core included in the optical fiber and on the bending angle. Accordingly, it can be seen that it is also necessary in a non-coupled multi-core optical fiber to measure the bending loss in all the cores and at a plurality of bending angles in order to acquire an average value of the bending losses.

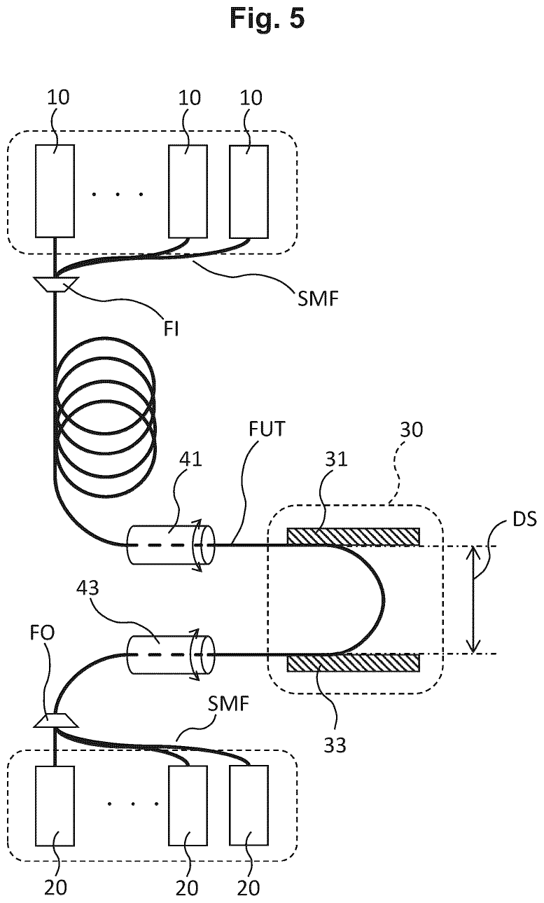

In addition, FIG. 5 is a schematic diagram illustrating a configuration of a loss measurement device according to a modification of the present disclosure. As illustrated in FIG. 5, one laser light source 10 may be provided for each core included in an optical fiber FUT to input light to one end of each core. Moreover, one measurement unit 20 may be provided for each core included in the optical fiber FUT to measure the intensity of light outputted from the other end of each core.

Note that a branching unit FI may be provided at one end of the optical fiber FUT in order to introduce light from the plurality of laser light sources 10 into each core of the optical fiber FUT. In addition, the plurality of laser light sources 10 and the cores of the optical fiber FUT may be connected via the branching unit FI. Similarly, a branching unit FO may be provided at the other end of the optical fiber FUT in order to introduce light from each core of the optical fiber FUT into the plurality of measurement units 20. In addition, the plurality of measurement units 20 and the cores of the optical fiber FUT may be connected via the branching unit FO.

### Example of Measurement by Loss Measurement Device

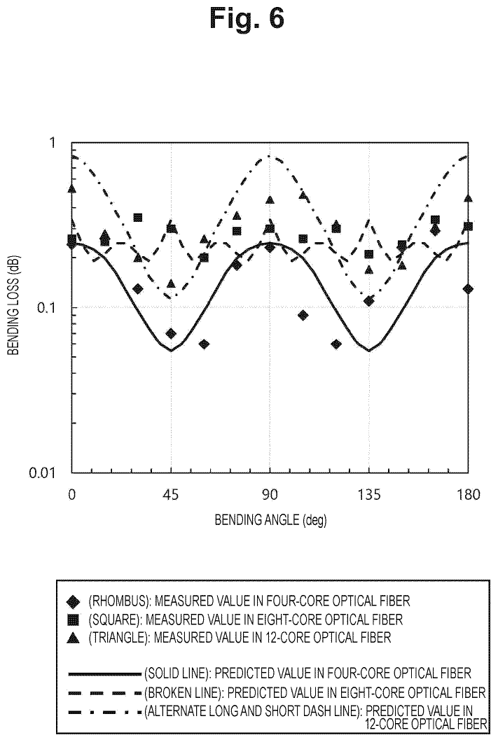

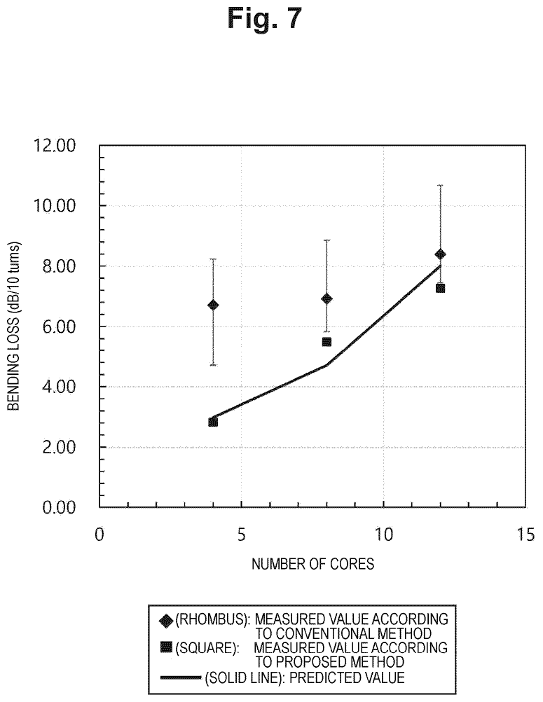

Next, an example of measurement by the loss measurement device will be described. FIG. 6 is a diagram illustrating an example of a measurement result of a bending loss with respect to a bending angle. Moreover, FIG. 7 is a diagram illustrating an example of an average value of measurement results of the bending loss.

In a case where the bending loss of the optical fiber FUT is measured using the loss measurement device, the optical fiber FUT is rotated using the rotation units 41 and 43, and a bending angle indicating a bending direction of the optical fiber FUT in a plane perpendicular to the central axis of the optical fiber FUT is set. The intensity of light outputted from the optical fiber FUT is measured at a plurality of bending angles. Then, the bending loss of the optical fiber FUT is calculated on the basis of the intensity of light at the plurality of bending angles.

In FIG. 6, measured values of the bending loss in a four-core optical fiber are each shown by a black rhombus. Moreover, measured values of the bending loss in an eight-core optical fiber are each shown by a black square. Moreover, measured values of the bending loss in a 12-core optical fiber are each shown by a black triangle. Furthermore, a predicted value of the bending loss in a four-core optical fiber is shown by a solid line. Moreover, a predicted value of the bending loss in an eight-core optical fiber is shown by a broken line. Moreover, a predicted value of the bending loss in a 12-core optical fiber is shown by an alternate long and short dash line. Note that the predicted values are calculated by simulating the bending loss of the optical fiber FUT. Moreover, the predicted values are obtained by signal-averaging numerical values in dB of all mode losses when all cores included in the optical fiber FUT are excited.

As illustrated in FIG. 6, the dependency of the bending loss on the bending angle is matched between the predicted value and the measured value. Accordingly, it can be seen that a bending loss of the optical fiber FUT with respect to an arbitrary bending angle can be measured by using a loss measurement device according to the present embodiment.

In FIG. 7, measured values of the bending loss (measured values according to a conventional method) measured by averaging the bending losses by increasing the number of windings of the optical fiber FUT are each shown by a black rhombus. Moreover, measured values of the bending loss (measured values according to the proposed method) calculated by averaging the bending losses at a plurality of bending angles measured using a loss measurement device according to the present embodiment are each shown by a black square. In addition, a predicted value of the bending loss calculated by averaging bending losses at a plurality of bending angles is shown by a solid line.

As illustrated in FIG. 7, the measured values by the proposed method are closer to the predicted values in comparison with the measured values by the conventional method. Accordingly, it can be seen that the bending loss of the optical fiber FUT can be accurately measured by using a loss measurement device according to the present embodiment.

### Effects of Embodiment

As described above in detail, a loss measurement device according to the present embodiment includes: a laser light source that inputs light to one end of an optical fiber; a measurement unit that measures intensity of light outputted from the other end of the optical fiber; a bend applying unit that inverts an extending direction of the optical fiber by bending with a predetermined bending radius; and a rotation unit that rotates a section of the optical fiber bent by the bend applying unit on a central axis of the optical fiber.

As a result, it is possible to stably measure the bending loss at a plurality of bending angles of an optical fiber without increasing the number of windings of the optical fiber, and easily calculate an average value of the bending losses at the plurality of bending angles.

Moreover, in a loss measurement device according to the present embodiment, the bend applying unit may include two parallel flat plates separated from each other by a distance twice the bending radius, and bend the optical fiber with the optical fiber sandwiched between the flat plates. As a result, the bending radius can be adjusted by adjusting the distance between the two parallel flat plates. In particular, since the bending radius can be adjusted with high accuracy without increasing the number of windings of the optical fiber, the bending loss can be measured accurately.

Furthermore, in a loss measurement device according to the present embodiment, the rotation unit may be installed at least either ahead or behind the section along the extending direction of the optical fiber. As a result, the optical fiber can be rotated on the central axis at an arbitrary angle, and the bending loss can be easily measured at a plurality of bending angles.

Moreover, in a loss measurement device according to the present embodiment, the maximum value of the rotation angle when the rotation unit rotates the section on the central axis may be 180 degrees or more. As a result, it is possible to reliably measure the bending loss at a plurality of bending angles necessary for calculating the average value of the bending losses regarding a multi-core optical fiber in which the bending loss varies depending on the bending angle.

Furthermore, in a loss measurement device according to the present embodiment, the rotation angle when the rotation unit rotates the section on the central axis may be settable with an angular resolution of 24 degrees or less. As a result, even in a case where the bending loss of a standard optical fiber is measured by an optical power meter having a power resolution of approximately 0.01 dB, it is possible to measure the bending loss at a plurality of bending angles with sufficient accuracy while reducing the relative error.

Moreover, in a loss measurement device according to the present embodiment, one laser light source may be provided for each core included in the optical fiber to input light to one end of each core. In addition, one measurement unit may be provided for each core included in the optical fiber to measure the intensity of light outputted from the other end of each core. As a result, even in a case where the bending loss is measured for each core included in a multi-core optical fiber, the bending loss can be simultaneously measured in the plurality of cores.

Furthermore, in a loss measurement device according to the present embodiment, the optical fiber may have at least two or more cores. Regarding a multi-core optical fiber in which the bending loss varies depending on the bending angle, the loss measurement device can easily measure the bending loss at a plurality of bending angles.

Moreover, a loss measurement method according to the present embodiment includes: rotating an optical fiber using a rotation unit of the loss measurement device described above; setting a bending angle indicating a bending direction of the optical fiber in a plane perpendicular to a central axis; and calculating a bending loss of the optical fiber on the basis of intensity at a plurality of bending angles. As a result, it is possible to stably measure the bending loss at a plurality of bending angles of an optical fiber without increasing the number of windings of the optical fiber, and easily calculate an average value of the bending losses at the plurality of bending angles.

Although the contents of the present disclosure have been described above according to the embodiment, the present disclosure is not limited to the description thereof, and it is obvious to those skilled in the art that various modifications and improvements can be made. It should not be construed that the present disclosure is limited to the description and the drawings that constitute a part of the present disclosure. Various alternative embodiments, examples, and operating techniques will be apparent to those skilled in the art from this disclosure.

It is needless to say that the present disclosure also includes various embodiments that are not described herein. Accordingly, the technical scope of the present disclosure is to be defined only by the invention specifying matters according to the scope of claims appropriately obtained from the above description.

### REFERENCE SIGNS LIST

10 laser light source
20 measurement unit
30 bend applying unit
31, 33 flat plate
41,43 rotation unit
43 rotation unit
CN connector
FI, FO branching unit
SMF, FUT optical fiber

1. A loss measurement device comprising:
a laser light source that inputs light to one end of an optical fiber;
measurement circuitry that measures intensity of light outputted from another end of the optical fiber;
a bender that inverts an extending direction of the optical fiber by bending with a predetermined bending radius; and
a rotator that rotates a section of the optical fiber bent by the bender on a central axis of the optical fiber.

2. The loss measurement device according to claim 1,
wherein the bender
includes two parallel flat plates separated from each other by a distance twice the bending radius, and
bends the optical fiber with the optical fiber sandwiched between the flat plates.

3. The loss measurement device according to claim 1, wherein
the rotator is installed at least either ahead or behind the section along an extending direction of the optical fiber.

4. The loss measurement device according to claim 1, wherein
a maximum value of a rotation angle when the rotator rotates the section on the central axis is 180 degrees or more.

5. The loss measurement device according to claim 1, wherein
a rotation angle when the rotator rotates the section on the central axis can be set with an angular resolution of 24 degrees or less.

6. The loss measurement device according to claim 1,
wherein one laser light source is provided for each core included in the optical fiber, and inputs light to one end of each core, and
one measurement circuitry is provided for each core included in the optical fiber, and measures intensity of light outputted from another end of each core.

7. The loss measurement device according to claim 1, wherein
the optical fiber has at least two or more cores.

8. A loss measurement method according to a loss measurement device including:
a laser light source that inputs light to one end of an optical fiber;
measurement circuitry that measures intensity of light outputted from another end of the optical fiber;
a bender that inverts an extending direction of the optical fiber by bending with a predetermined bending radius; and
a rotator that rotates a section of the optical fiber bent by the bender on a central axis of the optical fiber,
the loss measurement method comprising:
rotating the optical fiber using the rotator and setting a bending angle indicating a bending direction of the optical fiber in a plane perpendicular to the central axis; and
calculating a bending loss of the optical fiber on a basis of the intensity at a plurality of the bending angles.
